(19) United States
(12) Patent Application Publication
(10) Pub. No.: US 2013/0196001 A1
(43) Pub. Date: Aug. 1, 2013

(54) SALT REPLACEMENT COMPOSITIONS AND METHODS OF USING SAME

(71) Applicant: Health & Science, LLC, Baltimore, MD (US)

(72) Inventors: Richard D. Moore, Placitas, NM (US); Neil Solomon, Baltimore, MD (US)

(73) Assignee: Health & Science, LLC, Baltimore, MD (US)

(21) Appl. No.: 13/748,455

(22) Filed: Jan. 23, 2013

Related U.S. Application Data
(60) Provisional application No. 61/592,400, filed on Jan. 30, 2012.

(51) Int. Cl. A23L 1/237

(52) U.S. Cl. CPC A23L 1/237
USPC 424/679; 426/649; 426/73; 426/72; 426/74; 426/2

(57) ABSTRACT

Presented are salt replacement compositions and methods which are useful for replacing dietary sodium and for preventing and treating diseases associated with sodium overconsumption, including diabetes-Type 2.

### CROSS REFERENCE TO RELATED APPLICATIONS

This application claims priority to U.S. Provisional Application Ser. No. 61/592,400, entitled SALT REPLACEMENT COMPOSITIONS AND METHODS OF USING SAME, filed on Jan. 30, 2012, the entire contents of which are hereby incorporated by reference in its entirety.

### BACKGROUND OF THE INVENTION

1. Field

The present disclosure generally relates to salt replacement compositions and prevention and treatment of human diseases, including diabetes.

2. Description of the Related Art

Hypertension has been identified as a global health problem that in 95% of the cases is caused by excess sodium chloride intake. By virtue of the relationship existing between sodium consumption and high blood pressure, excess salt use exhibits a significant correlation to the incidence of Type II diabetes and other cardiovascular events (e.g., stroke, osteoporosis, gastric cancer, congestive heart failure, heart attack) consistent with acute or severe cardiovascular disease.

It has been estimated that reducing the average population sodium intake in the United States to 150 mg/d from current intake levels would reduce cases of hypertension by 11 million, saving $18 billion in health care dollars, and gaining 312,000 quality-adjusted life-years that are worth $32 billion annually, and eliminate up to 95% of hypertension.

The current standard of medical intervention generally entails the treatment of one patient at a time, either by physicians and/or by other trained and licensed health care providers. However, the ever-increasing list of diseases related to sodium consumption demonstrates that existing approaches have failed to reduce sodium consumption among the general population and thus increases the K/Na ratio. Improved strategies are needed to significantly reduce sodium consumption, and thereby prevent and treat diseases associated with overconsumption of sodium.

Accordingly, there exists a great need for cost-effective salt substitutes that can have a near immediate and positive impact on the health status of virtually the entire population.

### SUMMARY OF THE INVENTION

Presented herein is the surprising discovery of a healthy dietary salt replacement for prevention and amelioration of many illnesses. The salt replacement composition ratios presented herein are unique, for example, in processed foods as well as in individual use in restaurant and residential salt shakers. The salt replacement compositions presented herein are characterized by a healthy potassium/sodium ratio, and can be assimilated healthfully by humans, while restoring dietary K to Na ratio to normal values associated with the prevention of hypertension, probably diabetes and other diseases. Further, the salt replacement compositions presented herein are suitable for commercialization and global-scale distribution.

As described in greater detail below, it has been surprisingly discovered that insulin affects the electrical current generated by the K/Na pump that distributes electrical energy throughout the cell. Further, there is evidence suggesting the abnormally low K/Na ratio in the typical North American diet is a significant factor in causing diabetes Type-2 (DT2). Thus, the present inventors determined that increasing the K/Na ratio can prevent and/or ameliorate Diabetes Type-2. One of the inventors, Dr. Richard Moore, has surprisingly discovered evidence that a low K/Na ratio is one cause of Diabetes Type-2.

In accordance with the above, presented herein is a salt replacement composition for helping to prevent diabetes mellitus. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

In some embodiments, potassium is in the form of KCl. In some embodiments, sodium is in the form of NaCl.

In some embodiments, the salt replacement composition can further comprise, for example, one or more chemicals selected from the group consisting of: magnesium, iodine, calcium, chloride, biotin, chromium picolinate, citrate, and combinations thereof.

In certain aspects, the salt replacement composition can further comprise, for example, one or more chemicals selected from the group consisting of: amino acids, arginine, aspartate, beta-carotene, bicarbonate as NaHCO₃, cysteine, glutamate, inositol, protein-bound iodine, leucine, lysine, methionine, manganese, a monovalent chloride salt, phosphate, a phytochemical, a compound comprising umami, a ribonucleotide, a ribonucleotide-like substance, a compound comprising a tetrahydroimidizalone ring, Vitamin A, Vitamin C, Vitamin D, Vitamin E, and combinations thereof.

In certain aspects, the salt replacement composition can further comprise, for example, one or more chemicals selected from the group consisting of: Mg, Ca, taurine, Cl, chromium picolinate, citrate, an anion other than Cl such as an organic anion, and combinations thereof.

In certain aspects, the salt replacement composition can further comprise, for example, magnesium, calcium, chloride, 2-aminoethanesulfonic acid (taurine) and biotin.

Also presented herein is salt replacement composition having an identical flavor to table salt (NaCl). In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

In some embodiments, potassium is in the form of KCl. In some embodiments, sodium is in the form of NaCl.

In some embodiments, the salt replacement composition can further comprise, for example, one or more chemicals selected from the group consisting of: magnesium, iodine, calcium, chloride, taurine, biotin, chromium picolinate, citrate, and combinations thereof.

In certain aspects, the salt replacement composition can further comprise, for example, one or more chemicals selected from the group consisting of: amino acids, arginine, aspartate, beta-carotene, bicarbonate as NaHCO₃, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

In certain aspects, the salt replacement composition can further comprise, for example, one or more chemicals selected from the group consisting of: Mg, Ca, taurine, Cl, chromium picolinate, citrate, an anion other than Cl such as an organic anion, and combinations thereof.

In certain aspects, the salt replacement composition can further comprise, for example, magnesium, calcium, chloride, 2-aminoethanesulfonic acid (taurine) and biotin.

Also presented herein is a food product comprising a salt replacement composition, the composition comprising potassium and sodium in a K:Na ratio of at least 4.0, wherein the salt replacement provides an identical flavor to table salt (NaCl).

In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.0.

In some embodiments, potassium is in the form of KCl. In some embodiments, sodium is in the form of NaCl.

In some embodiments, the salt replacement composition can further comprise, for example, one or more chemicals selected from the group consisting of: magnesium, iodine, calcium, chloride, taurine, biotin, chromium picolinate, citrate, and combinations thereof.

In certain aspects, the salt replacement composition can further comprise, for example, one or more chemicals selected from the group consisting of: amino acids, arginine, aspartate, beta-carotene, bicarbonate as NaHCO₃, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

In certain aspects, the salt replacement composition can further comprise, for example, one or more chemicals selected from the group consisting of: Mg, Ca, taurine, Cl, chromium picolinate, citrate, an anion other than Cl such as an organic anion, and combinations thereof.

In certain aspects, the salt replacement composition can further comprise, for example, magnesium, calcium, chloride, 2-aminoethanesulfonic acid (taurine) and biotin.

Also presented herein is a nutritional supplement comprising potassium and sodium in a K:Na ratio of at least 4.0.

In some aspects, the K:Na ratio in the nutritional supplement is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

In some embodiments, potassium is in the form of KCl. In some embodiments, sodium is in the form of NaCl.

In some embodiments, the nutritional supplement can further comprise, for example, one or more chemicals selected from the group consisting of: magnesium, iodine, calcium, chloride, taurine, biotin, chromium picolinate, citrate, and combinations thereof.

In certain aspects, the nutritional supplement can further comprise, for example, one or more chemicals selected from the group consisting of: amino acids, arginine, aspartate, beta-carotene, bicarbonate as NaHCO₃, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

In certain aspects, the nutritional supplement can further comprise, for example, one or more chemicals selected from the group consisting of: Mg, Ca, taurine, Cl, chromium picolinate, citrate, an anion other than Cl such as an organic anion, and combinations thereof.

In certain aspects, the nutritional supplement can further comprise, for example, magnesium, calcium, chloride, 2-aminoethanesulfonic acid (taurine) and biotin.

Also presented herein are methods of reducing disease using the salt replacement compositions described herein. In some embodiments are presented methods of reducing the likelihood of diabetes mellitus in an individual. The methods can comprise, for example, providing a salt replacement composition to said individual, wherein said salt replacement composition comprises potassium and sodium in a K:Na ratio of at least about 4.0.

In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

In some embodiments, potassium is in the form of KCl. In some embodiments, sodium is in the form of NaCl.

In some embodiments, the salt replacement composition can further comprise, for example, one or more chemicals selected from the group consisting of: magnesium, iodine, calcium, chloride, taurine, biotin, chromium picolinate, citrate, and combinations thereof.

In certain aspects, the salt replacement composition can further comprise, for example, one or more chemicals selected from the group consisting of: amino acids, arginine, aspartate, beta-carotene, bicarbonate as NaHCO₃, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

In certain aspects, the salt replacement composition can further comprise, for example, one or more chemicals selected from the group consisting of: Mg, Ca, taurine, Cl, chromium picolinate, citrate, an anion other than Cl such as an organic anion, and combinations thereof.

In certain aspects, the salt replacement composition can further comprise, for example, magnesium, calcium, chloride, 2-aminoethanesulfonic acid (taurine) and biotin.

Also presented herein are methods of reducing the likelihood of stroke in an individual. The methods can comprise, for example, providing a salt replacement composition to said individual, wherein said salt replacement composition comprises potassium and sodium in a K:Na ratio of at least about 4.0.

Also presented herein are methods of reducing the likelihood of hypertension in an individual or in a population. The methods can comprise, for example, providing a salt replacement composition rather than NaCl to said individual, wherein said salt replacement composition comprises potassium and sodium in a K:Na ratio of at least 4.0.

Also presented herein are methods of reducing the probability of coronary artery disease in an individual resulting from processed foods. The methods can comprise, for example, providing a salt replacement composition to said individual, wherein said salt replacement composition comprises potassium and sodium in a K:Na ratio of at least 4.0.

Also presented herein are methods of reducing the incidence of gastric cancer in an individual. The methods can comprise, for example, providing a salt replacement composition to said individual, wherein said salt replacement composition comprises potassium and sodium in a K:Na ratio of at least 4.0.

Also presented herein are methods of reducing the likelihood of overweight in an individual. The methods can comprise, for example, providing a salt replacement composition to said individual, wherein said salt replacement composition comprises potassium and sodium in a K:Na ratio of at least about 4.0.

Also presented herein are methods of improving the health benefit of a salted food product. The methods can comprise, for example, preparing said food product with a salt replacement composition in place of table salt (NaCl), wherein said salt replacement composition comprises potassium and sodium in a K:Na ratio of at least 4.0.

In some aspects of the above-described methods, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

In some embodiments of the above-described methods, potassium is in the form of KCl. In some embodiments, sodium is in the form of NaCl.

In some embodiments of the above-described methods, the salt replacement composition can further comprise, for example, one or more chemicals selected from the group consisting of: magnesium, iodine, calcium, chloride, taurine, biotin, chromium picolinate, citrate, and combinations thereof.

In certain aspects of the above-described methods, the salt replacement composition can further comprise, for example, one or more chemicals selected from the group consisting of: amino acids, arginine, aspartate, beta-carotene, bicarbonate as NaHCO₃, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

In certain aspects of the above-described methods, the salt replacement composition can further comprise, for example, one or more chemicals selected from the group consisting of: Mg, Ca, taurine, Cl, chromium picolinate, citrate, an anion other than Cl such as an organic anion, and combinations thereof.

In certain aspects of the above-described methods, the salt replacement composition can further comprise, for example, magnesium, calcium, chloride, 2-aminoethanesulfonic acid (taurine) and biotin.

### BRIEF DESCRIPTION OF THE DRAWINGS

FIG. 1 is a graph illustrating the results of comparative taste tests between a replacement salt composition and regular table salt (NaCl). Over 96% of participants indicated that the taste of the salt replacement composition was indistinguishable from regular table salt (NaCl).

### DETAILED DESCRIPTION

Presented herein are salt replacement compositions and methods which are useful for replacing added dietary sodium. It has been discovered that these salt replacement compositions are surprisingly effective in preventing and treating diseases associated with sodium overconsumption.

Moreover, both healthy individuals (including those with varying degrees of sodium sensitivity) and hypertensive and/or diabetic consumers can benefit from the use of a salt replacement composition presented herein, given its capacity for prevention as well as amelioration of these conditions. Treatment of hypertension costs over 150 billion dollars per year in the United States alone. Thus, distribution of the salt replacement compositions presented herein would also serve to greatly reduce the overall cost of health care.

Prevention has broad implications for the improvement of public and population health in this country. It is widely understood that preventive measures constitute an important mechanism by which consumers and patients assume greater responsibility for their health care and, in turn, reduce the demand for costly intervention by physicians and other care providers.

The salt replacement compositions presented herein contain naturally-occurring elements, maintained in sustainable proportions, and thus can be distributed into industrialized as well as emerging economies and, in particular, economies of the developing world. In the latter case, distribution networks of non-governmental organizations (NGOs) can facilitate distribution among host country populations, including those that may be considered underserved. Also, in addition to the health and nutritional standards attained by the salt replacement compositions presented herein, the compositions presented herein provide an enhanced degree of salt taste intensity.

It will be appreciated that combining the intake of this nutritional alternative with medical intervention creates a synergistic effect, reinforcing the benefits of treatment modalities undertaken by trained practitioners.

There exists a great need for cost-effective nutritional substitutes that can have a near immediate and positive impact on the health status of virtually the entire population. Finland showed us how to do this on a national level when the country implemented a partial replacement of dietary sodium with potassium for human consumption. Even with the Finnish salt substitute containing too much NaCl and not enough K, the country still reduced strokes on a national level by 60%.

Another example from the Southern United States illustrates the role of dietary sodium chloride. A study begun in 1961 randomly selected both African Americans and whites living in Evans County, Georgia. The African Americans had a significantly higher incidence of hypertension than did the whites. This correlated with a decreased K to Na ratio compared to whites. This difference cannot be attributed to genetic factors because in rural Africa, where NaCl is seldom available for human consumption, blacks almost never get high blood pressure and their diets typically have a high K/Na ratio.

Within the medical and dietetic professions, there is a difference of opinion about the special role of sodium, Na+, within animal cells. We believe that sodium plays a special role unlike any other mineral within animal cells. Sodium also carries a positive charge, like potassium, hydrogen, and calcium, but, unlike any other substance, sodium ions (Na+) carry an electric current through all animal cells. In other words, all animal cells have within them an electric current carried by Na+ ions instead of the electrons carried in our radios and TV's.

This Na+ electric current is energized by the Na/K-pump that pushes sodium ions out of the cell through the surface (plasma) membrane of the cell. This sodium (Na+) electric current carries about 25% to 40% of all the energy contained a resting animal cell. This electric current, which is pushed out of the cell by the Na/K-pump, comes back into the cell interior through special molecular mechanisms within the surface membrane. These molecular mechanisms are able to use the energy they get from the sodium (Na+) current to move calcium and acid (H+, hydrogen ions) out of the cell. This movement of H+ ions is a key first step of stimulating glucose metabolism (glycolysis). Other molecular mechanisms located within the surface membrane use the energy provided by this sodium current to pull some amino acids into the cell.

There is evidence that when a person consumes too much dietary sodium or low K/Na ratio foods, this Na current decreases with the result that acid tends to build up inside the cell. Acid inside the cell disrupts normal cellular function. Thus, by ensuring the proper K/Na ratio, we have discovered a way to normalize the cellular membrane electrical current. The compositions disclosed herein and having a high K/Na ratio, over 4.0K/1Na, coupled with a sound diet (non-processed foods) and augmented with exercise can improve the faulty Na+ electrical current; every living animal cell has this vital Na+ current.

This scientific salt replacement of the present invention is based, in part, on the aggregate knowledge of the inventors, Drs. Richard Moore, M.D., Ph.D. and Neil Solomon, M.D., Ph.D. By way of background, the inventors wish to draw the reader's attention to the inventors' professional expertise in the area of salt replacement.

1954-1961. While as a combined medical/physiology graduate student at Case/Western Reserve University Medical Institutions (C/WRUMI) in Cleveland, Ohio, Dr. Neil Solomon started researching Na and K using the Rat Heart-Lung Preparation; Isolated Rat Heart Strips, and Rat Heart-Lung-Liver Preparations.

1961-1963. As an intern and Asst. Resident on the Osler Medical Service, at the Johns Hopkins Medical Institutions (JHMI), Baltimore, Md., Dr. Solomon clinically studied aspects of K/Na metabolism. Later in 1961, as an interne at the Johns Hopkins Hospital, Dr. Solomon received his Master of Science degree, MS, in Integrative Biological Sciences from C/WRUMI. During this time, Dr. Solomon worked with Dr. A. McGehee Harvey, Chairman & Professor, Dept. Medicine, Johns Hopkins Medical Institutions (JHMI) and researched Schmidt's Syndrome, which is adrenal and thyroid insufficiency. Dr. Solomon was interested in Na and K electrolyte imbalance as well as the co-existence of Diabetes mellitus-Type 2 (DM-T2). This work was, in part, responsible for Dr. Solomon receiving in 1963, the Johns Hopkins Schwentker Award for outstanding research as a House Officer.

1963-1965. Dr. Solomon joined the USPHS as Lt. Commander and continued his research on Na/electrolyte metabolism and its relationship to DM-T2, while receiving his Ph.D in Physiology at University of Maryland Medical Institutions (UMMI). Upon graduation, he was appointed Associate Professor of Physiology and Assistant Professor of Medicine.

1963-1964, Dr. Richard Moore, Research Assistant Professor, Dept. of Biophysics, University of Maryland School of Medicine. It was at this time that Dr. Richard Moore met Dr. Solomon and they exchanged ideas about the K/Na Pump.

1964-1967, Dr. Richard Moore, Associate Professor, Biophysics, State University of New York, College at Plattsburgh continued researching about the movement of K/Na and H+ across animal cell membranes.

1965-1969. As a faculty member of JHMI, Dr. Solomon continued his work on Schmidt's Syndrome and its relationship to K/Na and the association with DM-T2. He determined more optimal Na/electrolyte ratios might help make people healthier, and reduce the (slope) of rising of health care costs. It was during this period at UMMI that Dr. Solomon exchanged information with Postdoctoral Fellow, Dr. Richard Moore about K/Na flux ratios across cell membranes.

1966, Dr Neil Solomon received his Ph.D., University of Maryland, Md.; Dr. Richard Moore received his Ph.D., from Purdue University. Dr. Moore researched the relationship between sodium and diabetes in the Departments of Physiology and Biophysics at the University of Vermont and SUNY. Dr. Moore did basic research for over 40 years on K/Na across cell membranes. Dr. Solomon has communicated with him since 1964 about the K Factor and the K/Na ratios.

1975-1984 Dr. Richard Moore and Dr. Raj Gupta were the third group in the world to demonstrate the utility of Nuclear Magnetic Resonance in studying living cells.

Spring, 1976, Dr. Richard Moore was Visiting Scientist, Veterans Administration Hospital, Little Rock, Ark., Visiting Professor (Joint Appointment with SUNY).

1979 Dr. Richard Moore's lab demonstrated that lowering (blood) plasma insulin levels by either fasting or by streptozotocin (inhibits islet cells of pancreas) leads to increase in sodium inside muscle cells. Additionally, Dr. Richard Moore's lab demonstrated that the increased membrane voltage caused by insulin is caused by the hormone's stimulation of the Na—K-pump.

From 1973-1975, Dr. Richard Moore's lab was one of two that first discovered and demonstrated that insulin stimulates the Na—K pump.

1982-1987, Dr. Richard Moore researched the movement of K/Na and H+ flux across animal cell membranes at Dept. of Physiology and Biophysics, University of Vermont School of Medicine.

For nearly 30 years, Richard Moore was Professor of Biophysics of the State University of New York in Plattsburgh. During this time, Dr. Richard Moore gave 30 invited lectures at academic institutions that include Harvard, Yale, Duke and University of Illinois.

From 1969-1979, as Maryland's 1^{st} Secretary of Health & Mental Hygiene, Dr. Solomon concluded that if the population consumed less Na and had more optimal K/Na ratios, this would decrease the sharp rising slope of Maryland's and our nation's rising health costs. During this period, Dr. Solomon determined that optimizing the K/Na ratios could help reverse the obesity epidemic, which he predicted was coming to the United States. Dr. Solomon found during his over 30-year study of obese patients that one important factor in losing weight and keeping it off is to limit sodium ingestion to about 1,500 mg or less each day.

In 1972, Dr. Solomon with Sally Sheppard wrote a book for the public on obesity entitled, The Truth About Weight Control, which, was the first book about obesity that was accepted on the New York Times bestselling list.

1979-1981. Dr. Richard Moore's lab further discovered that by stimulating the Na:H exchange pump, insulin regulates the pH (acid level) inside cells. From 1979-1982, Dr. Richard Moore's lab decisively demonstrated that the elevation of pH inside muscle cells is the signal whereby insulin stimulates glycolysis (the first step in glucose metabolism).

Dr. Solomon researched patients on different K/Na ratio diets; and extrapolating from these diets, Dr. Solomon determined that he could find the optimal ratio, which Dr. Richard Moore and he have now done in the invention as described herein.

Dr. Richard Moore's group demonstrated that lowering (blood) plasma insulin levels either by fasting or by streptozotocin not only leads, as predicted, to an increase in sodium, a decrease in intracellular pH, but also a decrease in ATP inside muscle cells.

After retiring from the practice of medicine, Dr. Solomon devoted his time to studying a different method to fight against hypertension and other non-communicable diseases. Dr. Solomon postulated that decreasing ingested calories and Na, while eating more fruits, vegetables, whole grains and fiber should create a healthier K/Na ratio that could result in less hypertension and decrease some risk factors for cardiovascular disease. He further hypothesizes that decreasing ingested Na, and ingesting more K, coupled with healthy eating and exercise can help people lose excess weight and help keep it off. In 2006, Dr. Solomon received the Pioneer Award from ICCC/NGO/UN at the United Nations headquarters in New York for his years of pioneer research on healthful nutrition, including his work on non-communicable diseases and Na/electrolyte ratios.

### Sodium Reabsorption

Presented herein is the fact that sodium is reabsorbed from the urine when it is paired with chloride. However, when dietary sodium is paired with a different anion such as citrate, the sodium does not get reabsorbed as much by the kidney.

Accordingly, presented herein is the discovery of a salt replacement that includes Na in the form of another salt other than NaCl, such as Na citrate. This is predicated on some Cl being replaced by another anion. Thus, by limiting the amount of Cl anion in the salt mixture, the level of Na which gets absorbed from the urine is decreased. It will be appreciated that any suitable anion other than Cl can be utilized in Na salts in the salt replacement compositions.

Very low concentrations of insulin (38 micro units/ml) well below the amount needed for lowering blood sugar, stimulate the K/Na pump in the cell and type A amino acids into the cell. Considerably higher concentrations of insulin are required to move glucose into the cell, and lower blood sugar.

### Role of Insulin

Also presented herein is the surprising discovery that insulin stimulates the K/Na-pump and thus increases an outward electrical current, carried by the sodium ions (Na+), which returns through the surface membrane of each cell and provides the energy for secondary pumps to move both (H) and (Ca) out of the cell. This current also provides the energy to move type A amino acids into the cell. In the process the K/Na-pump maintains the high ratio of K/Na, which is required to conduct nerve impulses and trigger muscle contraction. Demonstrating the importance of normal function of the K/Na-pump is the fact that even partially inhibiting this mechanism always kills a cell, and the K/Na-pump uses between 25% and 40% of all the energy that all animal cells can provide. By increasing the activity of the K/Na-pump, insulin increases more energy and increases the movement of glucose into the cell.

The inventors of the present technology have discovered that that the low K/Na ratio of the American diet is one cause of Diabetes Type-2 (DT2). Surprisingly, however, the salt replacement compositions presented herein decrease this risk factor and help to prevent and/or ameliorate DT2. Thus, as described below, use of the salt replacement compositions presented herein in processed food, as well as use in salt shakers for home and restaurant use has the potential to significantly reduce not only hypertension and stroke, but also diabetes T-2.

### The Hypertension Problem

Hypertension has been identified as a global health problem that is caused by extreme excess NaCl intake that results in a K:Na ratio that is way too low. Evidence indicates that our excessively high daily intake of sodium is the cause of 95% of the cases of high blood pressure. Excess salt (NaCl) has also been shown to be a major cause of stroke (with or without high blood pressure), congestive heart failure, stomach cancer, osteoporosis, and as new evidence surfaces it will be recognized as a cause of DT-2. By virtue of the relationship existing between sodium chloride consumption and high blood pressure, excess NaCl use exhibits a significant correlation to the incidence of other cardiovascular events (e.g., stroke) consistent with acute or severe cardiovascular disease.

The inventors of the present disclosure have found that lowering blood pressure, through the reduction of excess sodium intake, has the greatest impact among elderly patients and individuals with higher starting blood pressures. Accordingly, presented herein are the results of efforts synthesizing a salt alternative (featuring an optimal potassium/sodium ratio), having a flavor indistinguishable from table salt (NaCl)., This will encourage usage and strong consumer demand, while producing the desired health outcomes across a broad range of demographic groups in the U.S. and around the world. Because of the surprising effects on hypertension, diabetes, and other diseases, the compositions presented herein can be readily and economically adopted by food processors as well as by individuals.

In addition to the above, presented herein is the surprising discovery that using the salt replacement compositions to vary the potassium/sodium ratio in healthy, hypertensive and diabetic subjects will affect the energy distribution and other dynamics within cells. These findings have value for other physicians/scientists conducting population-level research on a number of ailments, including, for example, noncommunicable diseases such as but not limited to vascular diseases, gastric cancer, osteoporosis, kidney stones and diabetes.

It will be appreciated that the compositions presented herein can be incorporated in any number of nutritional enhancement products. Over time, as these products are widely distributed, and subject to routine use, they will improve the general health and well-being of hundreds of millions across national boundaries, cultures and demographic and socioeconomic groups.

It will be appreciated that diffusing the salt replacement compositions presented herein into developing economies as a nutritional substitute will maintain the preservation properties of conventional table salt (NaCl), and enable consumers to contribute to the maintenance of their health and well-being. Additionally, such benefits can be realized while decreasing the need for medical attention, thereby increasing the effectiveness of certain ongoing therapies, and reducing the risk of adverse cardiovascular events, the development of diabetes, and many other illnesses, which can lead to hospitalization and other costly treatment. Thus, the compositions and methods provided herein represent a transfer of best practices to developing nations in the form of noncommunicable disease prevention and management and the empowerment of patients to make appropriate choices regarding their health care.

The compositions and methods provided herein thus can reduce the risk of cardiovascular morbidity and mortality, in addition to suppressing the demand for inpatient care and emergency room services, and can thus improve the overall quality of life enabling the aggregate cost of health care to gradually, but significantly decline.

### Salt Replacement Compositions

Presented herein are salt replacement compositions and methods which are effective and practical for replacing NaCl in food. It has been surprisingly discovered that these salt replacement compositions are effective in preventing and treating diseases associated with sodium overconsumption. One key aspect of the compositions provided herein is the K to Na ratio of at least about 4:1. As described below, K:Na at or above this particular ratio provides an optimal health benefit, and is not found in commercially available salt replacement compositions. Our salt replacement is safer than KCl because in the body Na and K are balanced against each other. K is a diuretic for Na, and Na is a diuretic for K. Thus, an overdose of our salt would be less likely to raise blood K to toxic amounts.

The salt replacement compositions provided herein represent a key advancement over existing compositions because the compositions presented herein are based upon a scientific understanding of the role of Na⁺ within the cells of the body. Excess table salt, NaCl, is not part of a healthy diet. Non-processed food has considerably less sodium and almost no chloride, compared to processed food. Only the blood of meat contains significant chloride.

Within the cells of the body, sodium levels are related to levels of potassium. Inside the cell, the Na⁺ levels cannot go down unless it is replaced by K. Likewise, Na⁺ levels cannot go up unless there is a decrease in K. This reciprocal relation between K and Na⁺ also applies to the whole body. If one increases his or her intake of K, this will drive Na out of the body through the urine. Similarly, if one increases the intake of Na, this will drive K out of the body through the urine. Thus, Na and K are diuretics for each other.

Notwithstanding the increasing awareness of the detrimental effects of sodium intake, current approaches to reduce sodium consumption among the population have had little effect. Accordingly, there is a great need for improved salt replacement compositions.

### K to Na Ratio

The proper balance between K and Na is expressed by their ratio, K/Na. In the cells in the body, the ratio of K to Na is about 15:1. This is also about the ratio of dietary K/Na that, before industrialization, human ancestors evolved upon. Thus, the human body is designed so that it needs very little Na. The National Academy of Science has determined that humans need only about 150 mg of Na per day. Duke University had large numbers of people with hypertension on a “rice-fruit” diet that had only 50 to 100 mg of Na per day. Although on this diet for years, none of the patients had any bad consequences. Based on many lines of evidence, a recommend daily Na intake is 100 to 400 mg. A main reason for this recommendation is that our bodies have mechanisms to retain most of the Na in our diet. In the kidney, Na is reabsorbed with chloride ions, and reabsorbed as NaCl.

In contrast, the amount of Na in processed food far exceeds these recommendations. For example, 300 to 400 mg of Na per serving is typical for some processed foods, with some servings containing over 1,000 mg of Na. Additionally, an unprocessed diet has not only much lower levels of Na, but very little of that Na is in the form of NaCl, whereas in processed food, almost all of the Na is due to added NaCl.

Instead of a dietary K/Na ratio of around 15/1, as humans had before food processing, the average Caucasian American has a dietary ratio of only about 0.6 and the average black American has a ratio of about 0.38. This distortion is partly due to a deficiency of K in the American diet, but is primarily due to an artificial overload of NaCl with Americans often consuming more than 4,000 mg of Na per day.

From the above, it will be appreciated that the ideal salt replacement will comprise a greater amount of K than Na. Presented herein is the key discovery that the K/Na ratio in a salt replacement is preferably about 4:1. Moreover, there should be some Na in the salt replacement composition to improve safety. Certain salt substitutes on the market consist of pure KCl and if taken in very large amounts, could increase the level of K in the blood plasma to near lethal levels. However, the salt replacement compositions presented herein advantageously also contain some Na, which is a diuretic for K. Thus, consumption of abnormally large amounts of the salt replacement compositions presented herein would be much safer due to the small amount of Na blunting the effect of K.

As used herein, the term K/Na ratio refers to the ratio, by weight, of potassium to sodium. Thus, a K/Na ratio of 4.0 denotes a composition having 4 times by weight more potassium than sodium. For example, a composition with a K/Na ratio of 4.0 could have 4 mg potassium and 1 mg sodium.

In accordance with the above, presented herein is a salt replacement composition for preventing diabetes mellitus, stroke, hypertension, coronary artery disease, cancer, obesity, and other diseases. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5. It will be appreciated that any other K:Na ratios above about 4.0 can be used in the compositions and methods presented herein.

Also presented herein are compositions further comprising Mg. Specifically, Mg is required for the kidney to optimally reabsorb K and excrete Na. Thus, in some embodiments, Mg is included in the compositions having a K:Na ratio of at least about 4.0. It will be appreciated that any suitable Mg salt can be utilized in the compositions. Thus, for example, in some embodiments, citrate, rather than chloride, is used as the anion for Mg.

Any suitable Na or K salt can be utilized in the salt replacement compositions. In some embodiments, potassium is in the form of KCl. In some embodiments, sodium is in the form of NaCl. Because chloride is required for the re-absorption of Na by the kidney, it will be appreciated that a non-chloride anion can be used for pairing with Na or with K. Thus, in some embodiments, the Na can be in the form of any one or more of the following salts, either alone or in combination: NaCl, Na Aspartate, NaI, and any other suitable sodium salt. Similarly, in some embodiments, the K can be in the form of any one or more of the following salts, either alone or in combination: KCl, K Aspartate, KI, and any other suitable K salt.

Accordingly, the salt replacement composition can be modified as desired with the interchangeable use of bio-chemicals, antioxidants, organic anions, and other nutrients. Na from table salt (NaCl) is readily reabsorbed by the kidney. However, an anion other than Cl prevents this rapid re-absorption of Na by the kidney, thus helping prevent retention of Na in the body.

In certain embodiments, the salt replacement composition further comprises taurine. Taurine is a metabolic product of amino acid metabolism that is naturally found in the human body and has been shown to be good for the heart. It also helps mask the metallic taste of KCl, thus providing an additional taste benefit.

Thus, in some embodiments, the salt replacement composition can further comprise, for example, one or more chemicals selected from the group consisting of: magnesium, iodine, calcium, chloride, taurine, biotin, chromium picolinate, citrate, and combinations thereof.

In certain aspects, the salt replacement composition can further comprise, for example, one or more chemicals selected from the group consisting of: amino acids, arginine, aspartate, beta-carotene, bicarbonate as NaHCO₃, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

In certain aspects, the salt replacement composition can further comprise, for example, one or more chemicals selected from the group consisting of: Mg, Ca, taurine, Cl, chromium picolinate, citrate, an anion other than Cl such as an organic anion, and combinations thereof.

In certain aspects, the salt replacement composition can further comprise, for example, magnesium, calcium, chloride, 2-aminoethanesulfonic acid (taurine) and biotin.

### Methods of Prevention and Treatment of Disease

Also presented herein are methods of reducing disease using the salt replacement compositions described herein. As described above, the compositions provided herein reduce elevated blood pressure and can play a role in hypertension prevention. Consequently, the use of the salt replacement compositions provided herein can, for example: i) decrease cardiovascular disease; ii) decrease the likelihood of Type II diabetes and decreases the likelihood for diabetes mellitus; and iii) reduce the likelihood for kidney disease. Among other benefits, reduction of these diseases can therefore help to lower the increasing slope of health care costs in the United States and internationally.

Accordingly, in some embodiments are presented methods of reducing the probability of diabetes mellitus in an individual. The methods can comprise, for example, providing a salt replacement composition to said individual, wherein said salt replacement composition comprises potassium and sodium in a K:Na ratio of at least 4.0. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

Also presented herein are methods of reducing the likelihood of stroke in an individual. The methods can comprise, for example, providing a salt replacement composition to said individual, wherein said salt replacement composition comprises potassium and sodium in a K:Na ratio of at least 4.0. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

Also presented herein are methods of reducing the likelihood of hypertension in an individual or in a population. The methods can comprise, for example, providing a salt replacement composition to said individual, wherein said salt replacement composition comprises potassium and sodium in a K:Na ratio of at least 4.0. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

Also presented herein are methods of reducing the likelihood of coronary artery disease in an individual. The methods can comprise, for example, providing a salt replacement composition to said individual, wherein said salt replacement composition comprises potassium and sodium in a K:Na ratio of at least 4.0. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

Also presented herein are methods of reducing the likelihood of gastric cancer in an individual. The methods can comprise, for example, providing a salt replacement composition to said individual, wherein said salt replacement composition comprises potassium and sodium in a K:Na ratio of at least 4.0. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5.

### Improved Taste and Health of Salted Food Products

The salt replacement compositions provided herein decrease the amount of Na ingested. However, surprisingly, people using the compositions provided herein are “salt satisfied” because use of these compositions does not require any behavior changes on their part except using the salt replacement composition instead of table salt (NaCl). Accordingly, the salt substitute compositions provided herein modify energy metabolism and allow use of sufficient energy for the K/Na pump to maintain the proper intracellular K/Na ratio.

Also presented herein is salt replacement composition having an identical flavor to table salt (NaCl). In one aspect of this embodiment, the salt replacement comprises potassium and sodium in a K:Na ratio of at least about 4.0. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5. It will be appreciated that any other K:Na ratios above about 4.0 can be used in the compositions and methods presented herein.

Accordingly, presented herein are methods of improving the health benefit of a salted food product. The methods can comprise, for example, preparing a food product with a salt replacement composition in the place of table salt (NaCl), wherein said salt replacement composition comprises potassium and sodium in a K:Na ratio of at least 4.0.

### Food

The salt replacement compositions provided herein can be provided in any suitable form, and can be incorporated, for example into a food product. The salt replacement composition can be used in any food-preparation process where table salt (NaCl) is normally used. For example, the salt replacement composition can be incorporated into a processed food product in a commercial restaurant, bakery, kitchen or other food production facility. Thus, in some embodiments our salt replacement was successfully used in baking foods. The salt replacement composition can be placed, shaken or sprinkled onto a food product, such as pretzels or French fries. In some embodiments, the salt replacement composition can be incorporated in place of table salt (NaCl) into a dough, dough mix, soup, soup mix, sauce, seasoning mix, or any other food composition or mixture that normally includes table salt (NaCl).

Accordingly, presented herein is a food product comprising a salt replacement composition, the composition comprising potassium and sodium in a K:Na ratio of at least 4.0, wherein the salt replacement provides an enhanced salty flavor. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5. It will be appreciated that any other K:Na ratios above about 4.0 can be used in the compositions and methods presented herein.

In some embodiments, the salt replacement composition can be provided as a condiment, for example, in the form of a salt packet or shaker. Such packets and shakers are commonly found at schools, restaurants, hospitals and hotels, or can be sold for home or institutional use.

### Medical Food Products

Medical foods are foods that are specially formulated and intended for the dietary management of a disease that has distinctive nutritional needs that cannot be met by normal diet alone. They were defined in the Food and Drug Administration's 1988 Orphan Drug Act Amendments and are subject to the general food and safety labeling requirements of the Federal Food, Drug, and Cosmetic Act.

Medical foods are distinct from the broader category of foods for special dietary use and from traditional foods that bear a health claim. In order to be considered a medical food the product must, at a minimum be a food for oral ingestion or tube feeding, be labeled for the dietary management of a specific medical disorder, disease or condition for which there are distinctive nutritional requirements, and be intended to be used under medical supervision.

Accordingly, presented herein is a medical food product such as, by not limited to a gluten free diet, comprising a salt replacement composition for the management of one or more specific medical disorders, the composition comprising potassium and sodium in a K:Na ratio of at least 4.0, wherein the salt replacement provides an enhanced salty flavor. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5. It will be appreciated that any other K:Na ratios above about 4.0 can be used in the compositions and methods presented herein.

In some embodiments, the salt replacement composition can be provided as a condiment, for example, in the form of a salt packet or shaker, as prescribed or recommended by a medical professional.

It will be appreciated that the medical food can be prescribed for any suitable medical disorder. In certain embodiments, the medical disorder can include, but is not limited to, such non-communicable diseases such as hypertension, Type-2 diabetes, vascular diseases, gastric cancer, osteoporosis, cataracts, and kidney stones.

Nutritional Products with Whey Protein and/or Gluconate

Also presented herein is a nutritional supplement comprising potassium and sodium in a K:Na ratio of at least 4.0. In one aspect of this embodiment, the salt replacement comprises potassium and sodium in a K:Na ratio of at least about 4.0. In some aspects, the K:Na ratio is at least about 4.0; 4.1; 4.2; 4.3; 4.4; 4.5; 4.6; 4.7; 4.8; 4.9; 5.0; 5.1; 5.2; 5.3; 5.4; 5.5; 5.6; 5.7; 5.8; 5.9; 6.0; 7.0; 8.0; 9.0; or at least about 10.0. In certain aspects, the K:Na ratio is between about 4.0; 4.1; 4.2; 4.3; 4.4; 4.5 and about 4.5. It will be appreciated that any other K:Na ratios above about 4.0 can be used in the compositions and methods presented herein.

In some embodiments, the salt replacement composition is combined with whey protein. For example, products comprising the salt replacement composition in combination with whey protein can be beneficial for use by hypertensive children or salt sensitive children, as well as adults. In certain embodiments, the product can comprise a whey protein-based composition with high potassium content. In contrast, in some embodiments, the salt replacement composition specifically does not comprise whey protein.

In some embodiments, the salt replacement composition is combined with aspartate. For example, products comprising the salt replacement composition in combination with aspartate can be beneficial for use by children as well as adults in need of nutritional supplementation. In certain embodiments, the product can comprise an aspartate-based composition with high potassium content. In contrast, in some embodiments, the salt replacement composition specifically does not comprise gluconate.

### EXAMPLES

The following examples, including the experiments conducted and results achieved are provided for illustrative purposes only and are not to be construed as limiting upon the teachings herein.

### Example 1

### Salt Replacement Formulation

A replacement salt composition was generated by mixing the following components: sodium chloride, potassium chloride, magnesium citrate, taurine, and a non-caking agent. The composition had nutritional characteristics as set forth in Table 1.

TABLE 1
Salt Replacement Composition. Serving Size ¼ tsp (1.2 g)

| Component | Amount in one serving | |
|---|---|---|
| Potassium | 387 | mg |
| Sodium | 96 | mg |
| Magnesium | 8 | mg |
| Taurine | 74 | mg |
| Iodine | 1 | microgram |
| K/Na ratio | 4.03 | |

### Example 2

### Salt Replacement Formulation

A replacement salt composition was generated by mixing the following components: sodium chloride, potassium chloride, and a non-caking agent. The composition had nutritional characteristics as set forth in Table 2.

TABLE 2
Salt Replacement Composition. Serving Size ¼ tsp (1.2 g)

| Component | Amount in one serving | |
|---|---|---|
| Potassium | 387 | mg |
| Sodium | 86 | mg |
| Magnesium | 8 | mg |
| Taurine | 74 | mg |
| Iodine | 1 | microgram |
| K/Na ratio | 4.5 | |

### Example 3

### Salt Replacement Formulation

A replacement salt composition was generated by mixing the following components: sodium chloride, potassium chloride, and a non-caking agent. The composition had nutritional characteristics as set forth in Table 3.

TABLE 3
Salt Replacement Composition.

| Component | Amount in one serving | |
|---|---|---|
| Potassium | 562 | mg |
| Sodium | 124 | mg |
| Magnesium | 11.6 | mg |
| Taurine | 107.4 | mg |
| Iodine | 1 | microgram |
| K/Na ratio | 4.5 | |

### Example 4

### Salt Replacement Formulation

A replacement salt composition was generated by mixing the following components: sodium chloride, potassium chloride, and a non-caking agent. The composition had nutritional characteristics as set forth in Table 4.

TABLE 4
Salt Replacement Composition.

| Component | Amount in one serving | |
|---|---|---|
| Potassium | 1985 | mg |
| Sodium | 496 | mg |
| Magnesium | 31 | mg |
| Taurine | 425 | mg |
| Iodine | 1 | microgram |
| K/Na ratio | 4.00 | |

### Example 5

### Use of Low Sodium Regimen to Normalize Blood Glucose Level

A 58 year old Asian male had a blood glucose of 400 mg % He resisted pressure to start drug treatment and instead discontinued use of soy sauce (which he had previously used in large amounts) and eliminated all other sources of NaCl from processed foods. After two to three weeks of this, his blood glucose level dropped from 400 mg % to a normal of 100 mg % to the amazement of his physician and family (most of whom were physicians). He has maintained his low NaCl diet and his blood glucose level have remained normal for 17 years.

### Example 6

### Use of Salt Replacement to Ameliorate Diabetes

A 63 year old female is diagnosed with Type II (adult onset) diabetes. She also presents with dangerously high blood pressure. She is advised by her doctor to reduce sodium intake. She replaces all NaCl in her diet with the salt replacement composition in Example 2. After three weeks of using the salt replacement composition, her blood pressure returns to normal levels and her blood glucose levels are normal. After six months of use, her blood glucose levels remain normal and her blood pressure is normal.

### Example 7

### Use of Salt Replacement to Ameliorate Obesity

A 45 year old male is diagnosed as morbidly obese and 1+ pretibial edema. He has a BMI score of 40. He is also diagnosed with hypertension. He is advised by his doctor to reduce sodium intake. He replaces all NaCl in his diet with the salt replacement composition in Example 1. After three weeks of using the salt replacement composition, his blood pressure returns to normal levels and he has lost 5 pounds of body weight. After six months of use, his blood pressure is normal and he has lost 45 pounds and lost his pretibial edema.

### Example 8

### Use of Salt Replacement to Help Ameliorate Stroke

A 70 year old female experiences slurred speech and partial loss of use of her left arm. She is rushed to the hospital and diagnosed with cerebral ischemia. She is advised by her doctor to reduce sodium intake. She replaces all NaCl in her diet with the salt replacement composition in Example 2. After two years of use, she has not experienced any further strokes.

### Example 9

### Use of Salt Replacement to Help Ameliorate Obesity and Type 2 Diabetes

A 54 year old, obese female patient with type 2 diabetes is advised by her doctor to reduce sodium in her diet by using no more NaCl salt from the salt shaker and replace it with the salt replacement composition in Example 1. She is further advised to only eat foods that are processed with the replacement composition in Example 1. After two months of using the salt replacement composition in Example 1, her blood pressure returns to normal and her blood glucose levels stabilize. After 9 months of use, her blood glucose level and blood pressure remain normal.

### Example 10

### Evaluation of Salty Taste of Salt Replacement Compositions

A taste test was conducted among a sampling of typical consumers of salty foods. The objective of the test to was to evaluate the salty taste satisfaction between table salt (NaCl) and the salt replacement compositions described herein.

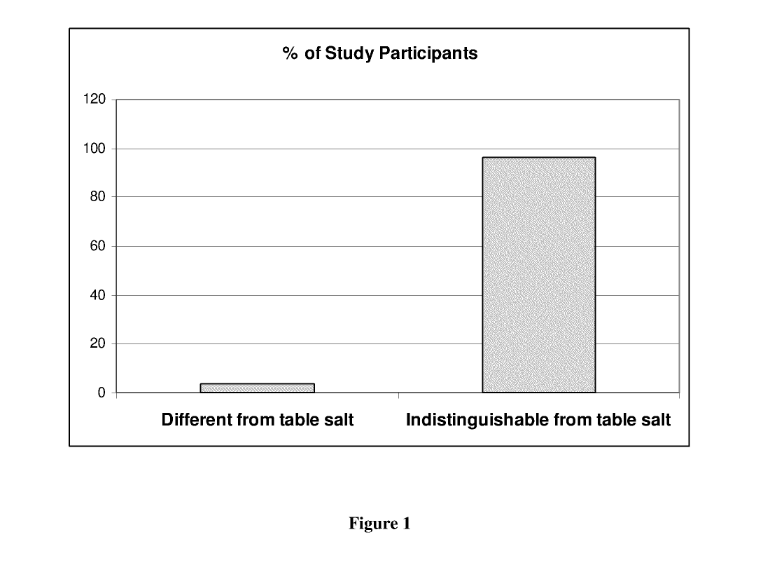

108 different individuals who regularly used regular NaCl table salt were given the unique ↑K/Na ratio alternative (SafeSalt™) set forth in Example 1 in a salt shaker. 104 out of the 108 participants indicated that the taste of SafeSalt™ was indistinguishable from that of normal table salt (NaCl). The results are illustrated in FIG. 1. Subjects indicated that SafeSalt™ looked like, felt like, and tasted like regular salt (NaCl). They said the taste was indistinguishable from the regular table salt (NaCl) they normally used.

### Example 11

### Use of Salt Replacement to Reduce Hypertension

A 54 year old male, RM, eating a diet primarily of frozen and canned food was diagnosed with a blood pressure of 160/120. Although he was advised by his doctor to begin taking medication to treat hypertension, he instead began reducing sodium in his diet. In a few weeks of doing so, his blood pressure was 120/80. Twenty years later, after eliminating all possible sources of table salt, (NaCl), he began using a salt replacement with an increased K/Na ratio and minimizing processed food, his blood pressure was 110/50.

What is claimed is:

1. A salt replacement composition for reducing conditions associated with a high salt diet, comprising:
potassium and sodium in a K:Na ratio of at least 4.0.

2. The composition of claim 1, wherein said K:Na ratio is between 4.0 and 4.5.

3. The composition of claim 1, wherein K is in the form of KCl.

4. The composition of claim 1, wherein Na is in the form of NaCl.

5. The composition of claim 1, wherein said composition further comprises one or more chemicals selected from the group consisting of: magnesium, iodine, calcium, chloride, taurine, biotin, chromium picolinate, citrate, and combinations thereof.

6. The composition of claim 1, wherein said composition further comprises one or more chemicals selected from the group consisting of: amino acids, arginine, aspirate, beta-carotene, bicarbonate as NaHCO3, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

7. The composition of claim 1, wherein said composition further comprises one or more chemicals selected from the group consisting of: magnesium, calcium, taurine, chloride, chromium picolinate, citrate, an anion other than chloride such as an organic anion and combinations thereof.

8. The composition of claim 1, wherein said composition further comprises magnesium, calcium, chloride, 2-aminoethanesulfonic acid (taurine) and biotin.

9. A food product comprising a salt replacement composition, said composition comprising potassium and sodium in a K:Na ratio of at least 4.0, wherein the salt replacement composition provides a salty flavor without providing the negative health conditions associated with a high sodium diet.

10. The food product of claim 9, wherein said K:Na ratio is between 4.0 and 4.5.

11. The food product of claim 9, wherein K is in the form of KCl.

12. The food product of claim 9, wherein Na is in the form of NaCl.

13. The food product of claim 9, wherein said composition further comprises one or
more chemicals selected from the group consisting of: magnesium, iodine, calcium, chloride, taurine, biotin, chromium picolinate, citrate, and combinations thereof.

14. The food product of claim 9, wherein said composition further comprises one or more chemicals selected from the group consisting of: amino acids, arginine, aspirate, beta-carotene, bicarbonate as NaHCO3, bioflavinoids, biotin, copper, cysteine, glutamate, inositol, protein-bound iodine, leucine, lysine, methionine, manganese, a monovalent chloride salt, phosphate, a phytochemical, a compound comprising a umami, a ribonucleotide, and a ribonucleotide-like substance.

15. The food product of claim 9, wherein said composition further comprises one or more chemicals selected from the group consisting of: Mg, Ca, taurine, Cl, chromium picolinate, citrate, an anion other than Cl such as an organic anion, and combinations thereof.

16. The food product of claim 9, wherein said composition further comprises magnesium, calcium, chloride, 2-aminoethanesulfonic acid (taurine) and biotin.

17. A method of reducing a negative health consequence associated with a high sodium diet in an individual in need thereof, comprising:
providing a salt replacement composition to said individual, wherein said salt replacement composition comprises potassium and sodium in a K:Na ratio of at least 4.0.

18. The method of claim 17, wherein said K:Na ratio is between 4.0 and 4.5.

19. The method of claim 17, wherein K is in the form of KCl.

20. The method of claim 17, wherein Na is in the form of NaCl.

21. The method of claim 17, wherein said composition further comprises one or more
chemicals selected from the group consisting of: magnesium, iodine, calcium, chloride, taurine, biotin, chromium picolinate, citrate, and combinations thereof.

22. The method of claim 17, wherein said composition further comprises one or more chemicals selected from the group consisting of: amino acids, arginine, aspirate, betacarotene, bicarbonate as NaHCO3, cysteine, glutamate, inositol, protein-bound iodine, leucine, lysine, methionine, manganese, a monovalent chloride salt, phosphate, a phytochemical, a compound comprising a umami, a ribonucleotide, a ribonucleotide-like substance, a compound comprising a tetrahydroimidizalone ring, Vitamin A, Vitamin C, Vitamin D, Vitamin E, and combinations thereof.

23. The method of claim 17, wherein said composition further comprises one or more chemicals selected from the group consisting of: Mg, Ca, taurine, Cl, chromium picolinate, citrate, an anion other than Cl such as an organic anion, and combinations thereof.

24. The method of claim 17, wherein said composition further comprises magnesium, calcium, chloride, 2-aminoethanesulfonic acid (taurine) and biotin.

25. The method of claim 17, wherein said negative health consequence is selected from the group consisting of stroke, hypertension, stomach cancer, obesity, and osteoporosis.
